(19) United States
(12) Patent Application Publication
(10) Pub. No.: US 2012/0143790 A1
(43) Pub. Date: Jun. 7, 2012

(54) RELEVANCE OF SEARCH RESULTS DETERMINED FROM USER CLICKS AND POST-CLICK USER BEHAVIOR OBTAINED FROM CLICK LOGS

(75) Inventors: Gang Wang, Beijing (CN); Weizhu Chen, Beijing (CN); Zheng Chen, Beijing (CN)

(73) Assignee: MICROSOFT CORPORATION, Redmond, WA (US)

(21) Appl. No.: 12/957,692

(22) Filed: Dec. 1, 2010

(51) Int. Cl. G06N 5/02; G06F 15/18

(52) U.S. Cl. 706/12; 706/52

(57) ABSTRACT

Data from a click log may be used to generate training data for a search engine. User click behavior and user post-click behavior may be used to assess the relevance of a page to a query. Labels for training data may be generated based on data from the click log. The labels may pertain to the relevance of a page to a query. For example, user post-click behavior that may be examined includes the amount of time that a user remains on a target page when a user clicks one of the search results.

### BACKGROUND

It has become common for users of host computers connected to the World Wide Web (the “web”) to employ web browsers and search engines to locate web pages having specific content of interest to users. A search engine, such as Microsoft's Live Search, indexes tens of billions of web pages maintained by computers all over the world. Users of the host computers compose queries, and the search engine identifies pages or documents that match the queries, e.g., pages that include key words of the queries. These pages or documents are known as a result set. In many cases, ranking the pages in the result set is computationally expensive at query time.

A number of search engines rely on many features in their ranking techniques. Sources of evidence can include textual similarity between query and pages or query and anchor texts of hyperlinks pointing to pages, the popularity of pages with users measured for instance via browser toolbars or by clicks on links in search result pages, and hyper-linkage between web pages, which is viewed as a form of peer endorsement among content providers. The effectiveness of the ranking technique can affect the relative quality or relevance of pages with respect to the query, and the probability of a page being viewed.

Some existing search engines rank search results via a function that scores pages. The function is automatically learned from training data. Training data is in turn created by providing query/page combinations to human judges who are asked to label a page based on how well it matches a query, e.g., perfect, excellent, good, fair, or bad. Each query/page combination is converted into a feature vector that is then provided to a machine learning algorithm capable of inducing a function that generalizes the training data.

For common-sense queries, it is likely that a human judge can come to a reasonable assessment of how well a page matches a query. However, there is a wide variance in how judges evaluate a query/page combination. This is in part due to prior knowledge of better or worse pages for queries, as well as the subjective nature of defining “perfect” answers to a query (this also holds true for other definitions such as “excellent,” “good,” “fair,” and “bad”, for example). In practice, a query/page pair is typically evaluated by just one judge. Furthermore, judges may not have any knowledge of a query and consequently provide an incorrect rating. Finally, the large number of queries and pages on the web implies that a very large number of pairs will need to be judged. It will be challenging to scale this human judgment process to more and more query/page combinations.

Click logs embed useful information about user satisfaction with a search engine and can provide a highly valuable source of relevance information. Compared to human judges, clicks are much cheaper to obtain and generally reflect current relevance. However, clicks are known to be biased by the presentation order, the appearance (e.g. title and abstract) of the documents, and the reputation of individual sites. Various attempts have been made to account for this and other biases that arise when analyzing the relationship between a click and the relevance of a search result. These models include the position model, the cascade model and the Dynamic Bayesian Network (DBN) model.

### BRIEF DESCRIPTION OF THE DRAWINGS

FIG. 1 illustrates an exemplary environment in which a search engine may operate.

FIG. 2 shows the average dwell time on documents that have been manually classified into one of three relevance levels.

FIG. 3 shows the Dynamic Bayesian Network used in the DBN model.

FIG. 4 shows the Bayesian network used in the PCC model.

FIG. 5 is an operational flow of an implementation of a method for generating training data from click logs.

FIG. 6 is an operational flow of an alternative implementation of a method for generating training data from click logs.

FIG. 7 compares the NDCG metric among the PCC, DBN and CCM models in terms of the query frequency.

FIG. 8 compares the NDCG metric among the PCC, DBN and CCM models in terms of the search position of a search result.

### SUMMARY

Data from a click log may be used to generate training data for a search engine. User click behavior and user post-click behavior may be used to assess the relevance of a page to a query. Labels for training data may be generated based on data from the click log. The labels may pertain to the relevance of a page to a query.

In an implementation, the user post-click behavior that is examined includes the amount of time that a user remains on a target page when a user clicks one of the search results. This time period may be referred to as the dwell time. In another implementation, two or more features characterizing user post-click behavior may be examined. These features may include, for instance, the user dwell time on a target page when a user clicks on of the search results, the user dwell time on a subsequent page that the user clicks on from the target page and which is within a domain to which the target page belongs, a time between initiation of a query and a new query, whether the user clicks on a subsequent page available from the target page, and whether the user switches to another search engine to input the query.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DETAILED DESCRIPTION

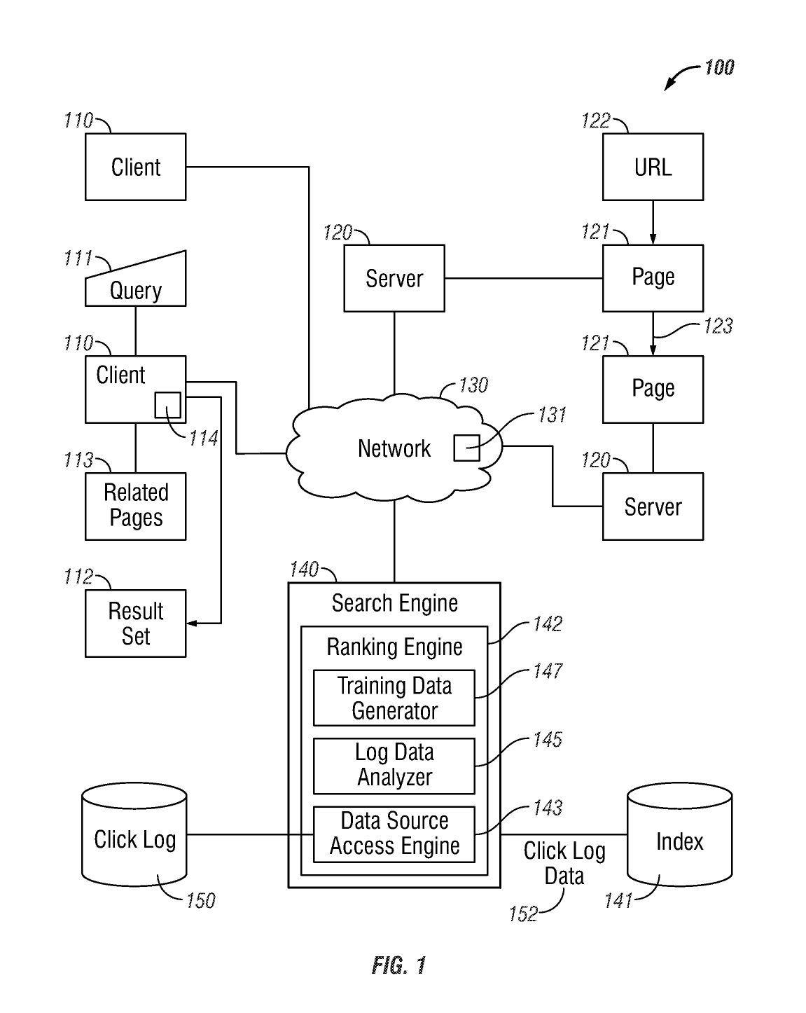

FIG. 1 illustrates an exemplary environment 100 in which a search engine may operate. The environment includes one or more client computers 110 and one or more server computers 120 (generally “hosts”) connected to each other by a network 130, for example, the Internet, a wide area network (WAN) or local area network (LAN). The network 130 provides access to services such as the World Wide Web (the “web”) 131.

The web 131 allows the client computer(s) 110 to access documents containing text-based or multimedia content contained in, e.g., pages 121 (e.g., web pages or other documents) maintained and served by the server computer(s) 120. Typically, this is done with a web browser application program 114 executing in the client computer(s) 110. The location of each page 121 may be indicated by a network address such as an associated uniform resource locator (URL) 122 that is entered into the web browser application program 114 to access the page 121. Many of the pages may include hyperlinks 123 to other pages 121. The hyperlinks may also be in the form of URLs. Although implementations are described herein with respect to documents that are pages, it should be understood that the environment can include any linked data objects having content and connectivity that may be characterized.

In order to help users locate content of interest, a search engine 140 may maintain an index 141 of pages in a memory, for example, disk storage, random access memory (RAM), or a database. In response to a query 111, the search engine 140 returns a result set 112 that satisfies the terms (e.g., the keywords) of the query 111.

Because the search engine 140 stores many millions of pages, the result set 112, particularly when the query 111 is loosely specified, can include a large number of qualifying pages. These pages may or may not be related to the user's actual information needs. Therefore, the order in which the result set 112 is presented to the client computer 110 affects the user's experience with the search engine 140.

In one implementation, a ranking process may be implemented as part of a ranking engine 142 within the search engine 140. The ranking process may be based upon a click log 150, described further herein, to improve the ranking of pages in the result set 112 so that pages 113 related to a particular topic may be more accurately identified.

For each query 111 that is posed to the search engine 140, the click log 150 may comprise the query 111 posed, the time at which it was posed, a number of pages shown to the user (e.g., ten pages, twenty pages, etc.) as the result set 112, and the page of the result set 112 that was clicked by the user. As used herein, the term click refers to any manner in which a user selects a page or other object through any suitable user interface device. Clicks may be combined into sessions and may be used to deduce the sequence of pages clicked by a user for a given query. The click log 150 may thus be used to deduce human judgments as to the relevance of particular pages. Although only one click log 150 is shown, any number of click logs may be used with respect to the techniques and aspects described herein.

The click log 150 may be interpreted and used to generate training data that may be used by the search engine 140. Higher quality training data may provide better ranked search results. The pages clicked as well as the pages skipped by a user may be used to assess the relevance of a page to a query 111. Additionally, labels for training data may be generated based on data from the click log 150. The labels may improve search engine relevance ranking.

Aggregating clicks of multiple users may provide a better relevance determination than a single human judgment. A user generally has some knowledge of the query and consequently multiple users that click on a result bring diversity of opinion. For a single human judge, it is possible that the judge does not have knowledge of the query. Additionally, clicks are largely independent of each other. Each user's clicks are not determined by the clicks of others. In particular, most users issue a query and click on results that are of interest to them. Some slight dependencies exist, e.g., friends could recommend links to each other. However, in large part, clicks are independent.

Because click data from multiple users is considered, specialization and a draw on local knowledge may be obtained, as opposed to a human judge who may or may not be knowledgeable about the query and may have no knowledge of the result of a query. In addition to more “judges” (the users), click logs also provide judgments for many more queries. The techniques described herein may be applied to head queries (queries that are asked often) and tail queries (queries that are not asked often). The quality of each rating improves because users who pose a query out of their own interest are more likely to be able to assess the relevance of pages presented as the results of the query.

The ranking engine 142 may comprise a log data analyzer 145 and a training data generator 147. The log data analyzer 145 may receive click log data 152 from the click log 150, e.g., via a data source access engine 143. The log data analyzer 145 may analyze the click log data 152 and provide results of the analysis to the training data generator 147. The training data generator 147 may use tools, applications, and aggregators, for example, to determine the relevance or label of a particular page based on the results of the analysis, and may apply the relevance or label to the page, as described further herein. The ranking engine 142 may comprise a computing device which may comprise the log data analyzer 145, the training data generator 147, and the data source access engine 143, and may be used in the performance of the techniques and operations described herein.

In a result set, small pieces of the page or document are presented to the user. These small pieces are known as snippets. It is noted that a good snippet (appearing to be highly relevant) of a document that is shown to the user could artificially cause a bad (e.g., irrelevant) page to be clicked more and similarly a bad snippet (appearing to be irrelevant) could cause a highly relevant page to be clicked less. It is contemplated that the quality of the snippet may be bundled with the quality of the document. A snippet may typically include the search title, a brief portion of text from the page or document and the URL.

It has been found that a user is more likely to click on higher ranked pages independent of whether the page is actually relevant to the query. This is known as position bias. One click model that attempts to address the position bias is the position click model. This model assumes that a user only clicks on a result if user actually examines the snippet and concludes that the result is relevant to the search. In addition, the model assumes that the probability of examination only depends on the position of the result. Another model, referred to as the examination click model, extends the position click model by rewarding relevant documents which are lower down in the search results by using a multiplication factor. The cascade click model extends the examination click model still further by assuming that the user scans the search results from top to bottom.

The aforementioned click models do not distinguish between the actual and perceived relevance of a result (i.e., a snippet). That is, when a user examines a result and deems it relevant, the user merely perceives that the result is relevant, but does not know conclusively. Only when the user actually clicks on the result and examines the page or document itself will the user be able to access whether the result is actually relevant. One model that does distinguish between the actual and perceived relevance of a result is the DBN model.

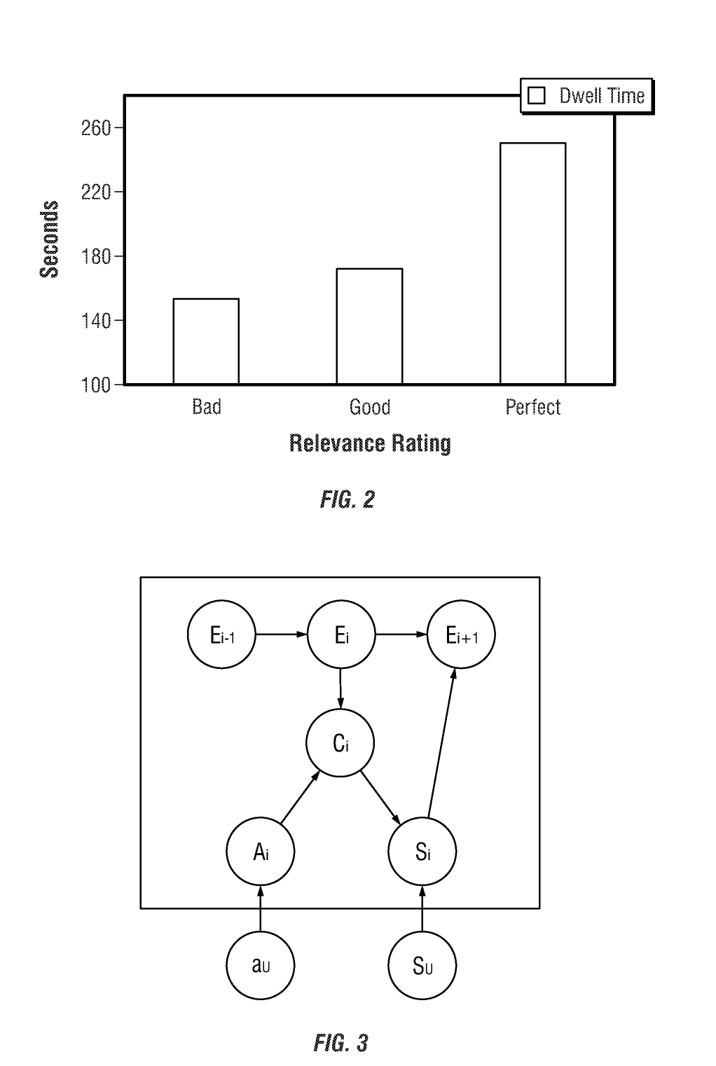

Despite their successes in solving the position-bias problem, the aforementioned click models mainly investigate user behavior with respect to the search page, without considering subsequent user behavior after a click. However, as the DBN model points out, a click only indicates that the user perceives the search snippet to be relevant, which does not necessarily mean that the clicked document is actually relevant or that the user is satisfied with the page or document. Although there is a correlation between clicks and document relevance, in many cases they will be different from one another. For example, given two documents with similar clicks, if users often spend a significant amount of time reading the first document while immediately closing the second document, it is likely that the users are satisfied with the first document and unsatisfied by the second document. Thus, the difference in the relevance between the two documents with respect to a given search can be identified from the post-click behavior of the users, such as the amount of time that a user spends with an open page or document (referred to herein as the “dwell time”). FIG. 2 shows the average dwell time on documents that have been manually classified into one of three relevance levels. It is clear that there is a strong correlation between the dwell time and the relevance rating, which validates the importance of incorporating user post-click behaviors to develop a better click model.

As discussed in detail below, a click model is presented herein which incorporates an unbiased estimation of relevance from both user clicks and post-click user behavior. This model is referred to as the post-clicked click model (PCC). In order to overcome the users' position bias, the PCC model follows the assumptions in the DBN model that distinguish between the perceived relevance and the actual relevance of a page or document. It assumes that the probability that a user clicks on a snippet after examination is determined by the perceived relevance, while the probability that a user examines the next document after a click is determined by the actual relevance of the previous document. In contrast to the DBN model, the PCC model also incorporates post-click behavior to estimate user satisfaction. Post click information is extracted from the post-click behavior and used as features that are shared across queries in the PCC model. Some post-click information that may be extracted may include, for example, the user dwell time on a target page when a search result is clicked on, the dwell time on a subsequent page that the user clicks on from the target page and which is within the same domain as the target page, the time between the initiation of the query session and a new query session, whether the user clicks on a subsequent page available from the target page, and whether the user switches to another search engine to input the same query.

In some implementations the PCC model is based on a probabilistic graphical model such as a Bayesian framework, for example, which is both scalable and incremental to handle the computational challenges when applied on a large scale to a constantly growing set of log data. The parameters for the posterior distribution can be updated in a closed form equation. Experimental studies on a data set with 54931 distinct queries and 140 million click sessions have been performed. The experimental results demonstrate that the PCC model significantly outperforms the DBN and other models that do not take post-click behavior into account.

Since the PCC model uses similar assumptions as the DBN model, the following notation used in the DBN model may be useful for describing aspects and implementations of the PCC model. FIG. 3 shows the Dynamic Bayesian Network used in the DBN model. The sequence is over the results in the search result list. The variables inside the box are defined at the session level, while those out of the box are defined at the query level.

For a given position i of a snippet in a search result list, the observed variable Cᵢ indicates whether or not there was a click at this position. In addition, the following hidden binary variables are defined in order to model the examination and perceived relevance of a snippet and the actual relevance of the corresponding page or document.

Eᵢ: did the user examine the snippet?

Aᵢ: was the user attracted by the snippet?

Sᵢ: was the user satisfied by the corresponding page or document?

The following equations describe the model:

Aᵢ=1, Eᵢ=1 [symbol] Cᵢ=1 (1a)

P(Aᵢ=1)=aᵤ (1b)

P(Sᵢ=1|Cᵢ=1)=sᵤ (1c)

Cᵢ=0 [symbol] Sᵢ=0 (1d)

Sᵢ=1 [symbol] Eᵢ₊₁=0 (1e)

P(Eᵢ₊₁=1|Eᵢ=1,Sᵢ=0)=γ (1f)

Eᵢ=0 [symbol] Eᵢ₊₁=0 (1g)

The model assumes that there is a click if and only if the user looks at the snippet and is attracted by it (equation 1a). The probability of being attracted depends only on the snippet (equation 1b). The user is assumed to scan the snippets linearly from top to bottom until he decides to stop. After the user clicks and views the page, there is a certain probability that he will be satisfied by this page (equation 1c). On the other hand, if he does not click, he will not be satisfied (equation 1d). Once the user is satisfied by the page he has visited, he stops his search (equation 1e). If the user is not satisfied by the current result, there is a probability 1−γ that the user abandons his search (equation 10 and a probability γ that the user examines the next snippet. In other words, γ measures the perseverance of the user. If the user does not examine the snippet at position i, he will not examine the subsequent positions (equation 1g). In addition, aᵤ and sᵤ have a beta prior. The choice of this prior is natural because the beta distribution is conjugate to the binomial distribution.

The PCC model also uses data obtained from behavior logs, which are logs provided by anonymous users who opt-in through, for example, a browser toolbar. The entries in the log include a (anonymous) identifier for the user, the query issued to the search engine, the page or documents visited, and a timestamp for each page viewed and possibly a timestamp for the search query. The behavior logs are processed to extract all the post-click behaviors that occur after the user has clicked on a page or document available from the search page. As previously mentioned, some of the post-click behavior features that may be extracted from the post-click behavior logs illustratively include:

The dwell time on a target page when a search result is clicked on by the user;

The dwell time on a subsequent page that the user clicks on from the target page and which is within the same domain as the target page;

The time between the initiation of the query session and a new query session;

Whether the user clicks on a subsequent page available from the target page; and

Whether the user switches to another search engine to input the same query.

For each query and document pair, the average value of one or more of each of the above-listed behavior features is calculated over multiple related sessions. These average values may then be used to calculate the parameters used in the PCC model, which will be described in more detail below.

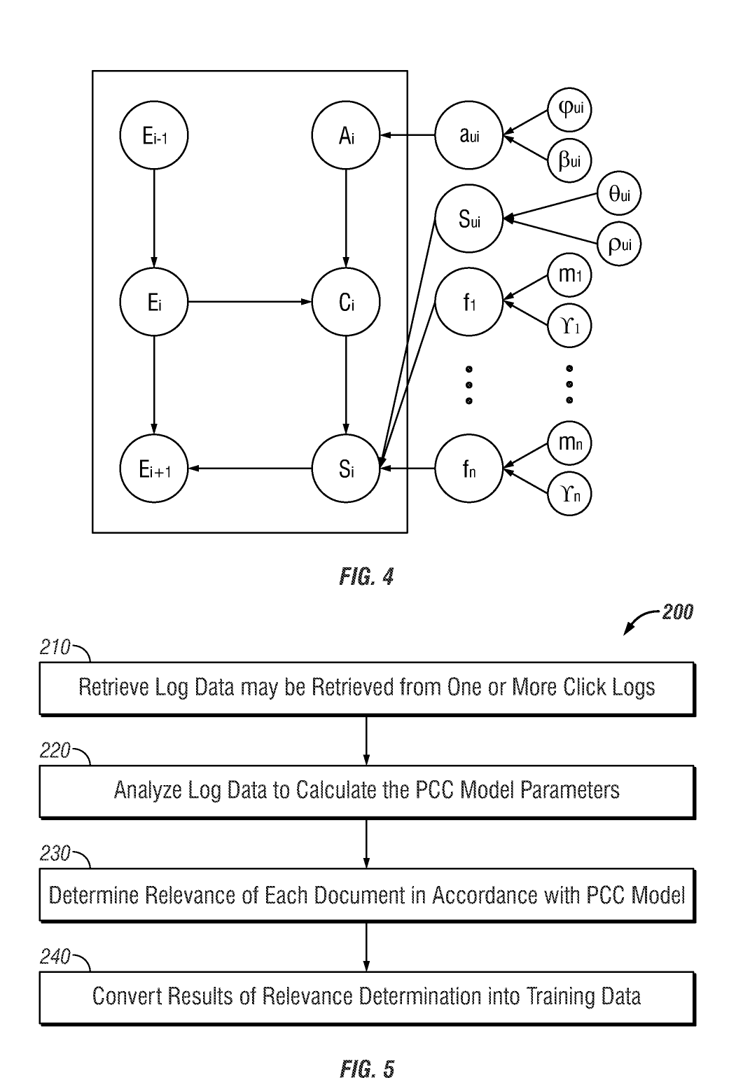

The PCC model, which leverages both click-through behaviors on the search results page and the post-click behaviors after a click, may use the Bayesian network shown in FIG. 4, where the variables inside the box are defined at the session level, and the variables outside are defined at the query level. The variables Eᵢ, Cᵢ, and Sᵢ are as defined above. In this example n post-click features are extracted from the user post-click behavior logs and fᵢ is the feature value of the with feature.

F(10 (2)

αᵤ˜N(φᵤ,βᵤ²), sᵤ˜N(θᵤ,ρᵤ²),fᵢ˜N(mᵢ,γᵢ²).

Thus, φᵤ and β²ᵤ are the parameters of the perceived relevance, variables aᵤ, θᵤ, and ρ²ᵤ are the parameters of the real relevance and variable sᵤ, and mᵢ and γ²ᵢ are the parameters of the ith feature variable fᵢ.

The PCC model is characterized by the following equations:

Eᵢ=1 (3)

Aᵢ=1, Eᵢ=1 [symbol] Cᵢ=1 (4)

P(Aᵢ=1|Eᵢ=1)=P(aᵤ+ε>0) (5)

P(Sᵢ=1|Cᵢ=1)=P(sᵤ+Σₙ₌₁ⁿy_{u,i}fᵢ+ε>0) (6)

Cᵢ0 [symbol] Sᵢ=0 (7)

Sᵢ=1 [symbol] Eᵢ₊₁=0 (8)

P(Eᵢ₊₁=1|Eᵢ=1,Sᵢ=0)=λ (9)

Eᵢ=0 [symbol] Eᵢ₊₁=0, (10)

where ε˜N(0, β²) is an error parameter and γ_{u,i} is a binary value indicating whether the value of the ith feature can be extracted on the document u. It is possible that, for a document u, no user has clicked this document and therefore no information is available to extract from the post-click behavior on the ith feature. Thus, γ_{u,i}=0 in this case. Otherwise, γ_{u,i}=1.

The FCC model simulates user interactions with the search engine results. When a user examines the ith document, he will read the snippet, and the degree to which he deems it pertinent depends on the perceived relevance parameter of the corresponding document aᵤᵢ. If the user is not attracted by the snippet (i.e., Aᵢ=0), he will not click on it, which indicates he is not satisfied with the document (i.e., Sᵢ=0). Thus, there is a probability that the user will examine the next document at the position i+1, and a probability 1−λ that the user stops his search at this point. If the user is attracted by the snippet (i.e., Aᵢ=1), he will click on it and view the corresponding document. User post-click behaviors on the clicked document are very useful tools to infer to what degree the user is satisfied with a given document. If the user is satisfied (i.e., Sᵢ=1), he will stop the search session. Otherwise, he will either stop the search session or examine the next snippet and corresponding document, depending on the probability.

Equations (3) and (10) reflect the cascade hypothesis and equation (4) reflects the examination hypothesis. When a user examines the document, equation (5) indicates that whether the user would or would not click on a snippet depends on the variable aᵤᵢ and an error term. When a user clicks a snippet and views the corresponding document, equation (6) shows that the value of the post-click behavior features will affect the user's satisfaction with the document. The equation (7) and (8) mean that the user will not be satisfied if he does not click the document, while the user will stop the search when he is satisfied. The equation (9) shows that if user is not satisfied by the clicked document, the probability that he continues browsing the next search result is λ while the probability he abandons the session is 1−λ.

After click data is obtained during a search session the PCC parameters defined above may be calculated for each document used during a query session. This can be accomplished by classifying each document into one of five cases. The manner in which the PCC parameters are updated will differ for each case. In particular, if l is denoted as the position of the document in the search result list that was last clicked, l=0 corresponds to a session with no click, and l>0 corresponds to a session with clicks. Two sets of positions can be defined. A is the set of positions in the search result list before the last click and B is the set of positions in the search result list after the last click. Thus, the five cases are defined as follows:

Case 1: l=0, which indicates there is no click in the session. In this case, the parameters of the kth document are updated with equation (17). Parameters not updated remain unchanged.

Case 2: l>0; kεA; Cₖ=0, which indicates the kth document is at a non-clicked position before the position in the search results of the last clicked document. In this case, the parameters are updated with equation (19). Parameters not updated remain unchanged.

Case 3: l>0; kεA; Cₖ=1, which indicates the kth document is at a clicked position before the position in the search results of the last clicked document. In this case, the parameters are updated with equations (20), (21) and (22). Parameters not updated remain unchanged.

Case 4: l>0; k=1; Cₖ=1, which indicates the kth document is at the last clicked position in the search results. In this case, the parameters are updated with equations (23), (24) and (26). Parameters not updated remain unchanged.

Case 5: l>0; kεB; Cₖ=0, which indicates the kth document is at the position in the search results after the last click. In this case, the parameters are updated with the equation (27). Parameters not updated remain unchanged.

For a fixed k(1≦k≧M), if x is the parameter that is to be updated, the posterior distribution may be obtained from the following the equation:

p(x|C^{A:k})∝p(x)×P(C^{A:k}|x) (12)

This distribution may be approximated to a Gaussian distribution use KL-divergence. This method for deriving the updating formula is based on the message passing and the expectation propagation, which are respectively discussed in the following two references, which are hereby incorporated by reference in their entirety: F. R. Kschischang, et al. Factor Graphs and the Sum-Product Algorithm. IEEE Transactions on Information Theory, 1998; T. Minka. A Family of Algorithms for Approximate Bayesian Inference. PH.D thesis, Massachusetts Institute of Technology. 2001. For convenience, some functions that will be used in the following parameter update equations are now presented:

$$\begin{matrix}N ( c ) = \frac{1}{2 π} {ɛ}^{\frac{- {c}^{2}}{2}} ; & ( 13 ) \\ Φ ( c ) = {\int }_{- ∞}^{c} N ( x ) d x ; & ( 14 ) \\ v ( c , ω ) = \frac{N ( c )}{Φ ( c ) + \frac{ω}{1 - ω}} ; & ( 15 ) \\ w ( c , ω ) = v ( c , ω ) ( v ( c , ω ) + c ) . & ( 16 )\end{matrix}$$

For the kth document, the observation is A₁=0; E₁=1; Cᵢ=0; 1≦i≦k. The parameters related to the ith document are updated. The updated parameter is for the perceived relevance:

$$\{ \begin{matrix}{ϕ}_{{u}_{k}} ← {ϕ}_{{u}_{k}} - \frac{{β}_{{u}_{k}}^{2} ν ( c , {ω}_{1 , k} )}{{( {β}^{2} + {β}_{{u}_{k}}^{2} )}^{\frac{1}{2}}} \\ {β}_{{u}_{k}}^{2} ← {β}_{{u}_{k}}^{2} ( 1 - \frac{{β}_{{u}_{k}}^{2} w ( c , {ω}_{1 , k} )}{{β}^{2} + {β}_{{u}_{k}}^{2}} ) \\ c = - \frac{{ϕ}_{{u}_{k}}}{{( {β}^{2} + {β}_{{u}_{k}}^{2} )}^{\frac{1}{2}}}\end{matrix}$$

Where ω_{l,k} is a coefficient whose value is given by:

$${ω}_{1 , k} = 1 - \frac{λ g ( k - 1 , 0 )}{( 1 - λ ) {\sum }_{j = 0}^{k - 2} g ( j , 0 ) + g ( k - 1 , 0 )} \qquad ( 18 )$$

The parameters of the features and the real relevance are kept the same.

### Case 2:

For the kth document, the observation is Aₖ=0; Eₖ=1. Thus, the parameters related to the kth document are updated. The updated parameter is for the perceived relevance:

$$\{ \begin{matrix}{ϕ}_{{u}_{k}} ← {ϕ}_{{u}_{k}} - \frac{v ( c , 0 ) {β}_{{u}_{k}}^{2}}{{( {β}_{{u}_{k}}^{2} + {β}^{2} )}^{\frac{1}{2}}} \\ {β}_{{u}_{k}}^{2} ← {β}_{{u}_{k}}^{2} ( 1 - \frac{{β}_{{u}_{k}}^{2} w ( c , 0 )}{{β}_{{u}_{k}}^{2} + {β}^{2}} ) \\ c = \frac{- {ϕ}_{{u}_{k}}}{{( {β}_{{u}_{k}}^{2} + {β}^{2} )}^{\frac{1}{2}}} .\end{matrix} \qquad ( 19 )$$

The parameters of the features and the real relevance are kept the same.

### Case 3:

For the kth document, the observation is Aₖ=1; Eₖ=1 and Sₖ=0. Thus, the parameters related to the kth document are updated. The updated parameter for the perceived relevance is:

$$\{ \begin{matrix}{ϕ}_{{u}_{k}} ← {ϕ}_{{u}_{k}} + \frac{v ( c , 0 ) {β}_{{u}_{k}}^{2}}{{( {β}_{{u}_{k}}^{2} + {β}^{2} )}^{\frac{1}{2}}} \\ {β}_{{u}_{k}}^{2} ← {β}_{{u}_{k}}^{2} ( 1 - \frac{{β}_{{u}_{k}}^{2} w ( c , 0 )}{{β}_{{u}_{k}}^{2} + {β}^{2}} ) \\ c = \frac{{ϕ}_{{u}_{k}}}{{( {β}_{{u}_{k}}^{2} + {β}^{2} )}^{\frac{1}{2}}} .\end{matrix} \qquad ( 20 )$$

The update of the parameter for the feature is:

$$\{ \begin{matrix}{m}_{i} ← {m}_{i} - \frac{v ( c , 0 ) \text{?}}{{( {\sum }_{j = 1}^{n} \text{?} + {ρ}_{{u}_{k}}^{2} + {β}^{2} )}^{\frac{1}{2}}} \\ {γ}_{i}^{2} ← {γ}_{i}^{2} ( 1 - \frac{{γ}_{i}^{2} w ( c , 0 ) \text{?}}{{\sum }_{j = 1}^{n} \text{?} + {ρ}_{{u}_{k}}^{2} + {β}^{2}} ) \\ c = \frac{- ( {θ}_{{u}_{k}} + {\sum }_{j = 1}^{n} \text{?} )}{{( {\sum }_{j = 1}^{n} \text{?} + {ρ}_{{u}_{k}}^{2} + {β}^{2} )}^{\frac{1}{2}}} .\end{matrix} \\ \text{?} \text{indicates text missing or illegible when filed} \qquad ( 21 )$$

The update of the parameter for the real relevance is:

$$\{ \begin{matrix}{θ}_{{u}_{k}} ← {θ}_{{u}_{k}} - \frac{v ( c , 0 ) {ρ}_{{u}_{k}}^{2}}{{( {\sum }_{j = 1}^{n} \text{?} + {ρ}_{{u}_{k}}^{2} + {β}^{2} )}^{\frac{1}{2}}} \\ {ρ}_{{u}_{k}}^{2} ← {ρ}_{{u}_{k}}^{2} ( 1 - \frac{{ρ}_{{u}_{k}}^{2} w ( c , 0 )}{{\sum }_{j = 1}^{n} \text{?} + {ρ}_{{u}_{k}}^{2} + {β}^{2}} ) \\ c = \frac{- ( {θ}_{{u}_{k}} + {\sum }_{j = 1}^{n} \text{?} )}{{( {\sum }_{j = 1}^{n} \text{?} + {ρ}_{{u}_{k}}^{2} + {β}^{2} )}^{\frac{1}{2}}}\end{matrix} \\ \text{?} \text{indicates text missing or illegible when filed} \qquad ( 22 )$$

### Case 4

For the last clicked document, the observation is Cₗ=1; Cᵢ=0 (i=l+1 to M) and the parameters related to the lth document are updated. The update of the parameters in the perceived relevance is:

$$\{ \begin{matrix}{ϕ}_{{u}_{l}} ← {ϕ}_{{u}_{l}} + \frac{v ( c , 0 ) {β}_{{u}_{l}}^{2}}{{( {β}_{{u}_{l}}^{2} + {β}^{2} )}^{\frac{1}{2}}} \\ {β}_{{u}_{l}}^{2} ← {β}_{{u}_{l}}^{2} ( 1 - \frac{{β}_{{u}_{l}}^{2} w ( c , 0 )}{{β}_{{u}_{l}}^{2} + {β}^{2}} ) \\ c = \frac{{ϕ}_{{u}_{l}}}{{( {β}_{{u}_{l}}^{2} + {β}^{2} )}^{\frac{1}{2}}} .\end{matrix} \qquad ( 23 )$$

The update of the parameters in the feature is:

$$\{ \begin{matrix}{m}_{i} ← {m}_{i} + \frac{v ( c , {ω}_{2} ) {γ}_{i}^{2}}{{( {\sum }_{j = 1}^{n} {y}_{{u}_{l} , j} {γ}_{j}^{2} + {ρ}_{{u}_{l}}^{2} + {β}^{2} )}^{\frac{1}{2}}} \\ {γ}_{i}^{2} ← {γ}_{i}^{2} ( 1 - \frac{{γ}_{i}^{2} w ( c , {ω}_{2} )}{{\sum }_{j = 1}^{n} {y}_{{u}_{l} , j} {γ}_{j}^{2} + {ρ}_{{u}_{l}}^{2} + {β}^{2}} ) \\ c = \frac{( {θ}_{{u}_{l}} + {\sum }_{j = 1}^{n} {y}_{{u}_{l} , j} {m}_{j} )}{{( {\sum }_{j = 1}^{n} {y}_{{u}_{l} , j} {γ}_{j}^{2} + {ρ}_{{u}_{l}}^{2} + {β}^{2} )}^{\frac{1}{2}}}\end{matrix} \qquad ( 24 )$$

Where ω₂ is a coefficient whose value is give by:

$${ω}_{2} = ( 1 - λ ) {\sum }_{j = l}^{M - 1} g ( j , l ) + g ( M , l ) \qquad ( 25 )$$

The update for the parameters is:

$$\{ \begin{matrix}{θ}_{{u}_{l}} ← {θ}_{{u}_{l}} + \frac{v ( c , {ω}_{2} ) {ρ}_{{u}_{l}}^{2}}{{( {\sum }_{j = 1}^{n} {y}_{{u}_{l} , j} {γ}_{j}^{2} + {ρ}_{{u}_{l}}^{2} + {β}^{2} )}^{\frac{1}{2}}} \\ {ρ}_{{u}_{l}}^{2} ← {ρ}_{{u}_{l}}^{2} ( 1 - \frac{{ρ}_{{u}_{l}}^{2} w ( c , {ω}_{2} )}{{\sum }_{j = 1}^{n} {y}_{{u}_{l} , j} {γ}_{j}^{2} + {ρ}_{{u}_{l}}^{2} + {β}^{2}} ) \\ c = \frac{( \text{?} + {\sum }_{j = 1}^{n} \text{?} )}{{( {\sum }_{j = 1}^{n} \text{?} {γ}_{j}^{2} + {ρ}_{{u}_{l}}^{2} + {β}^{2} )}^{\frac{1}{2}}}\end{matrix} \\ \text{?} \text{indicates text missing or illegible when filed} \qquad ( 26 )$$

For the kth document, the observation is Cₗ=1; Cₖ=0(k=l+1 to M). Thus the parameter related to the kth document is updated. The update of the parameter for the perceived relevance is:

$$\{ \begin{matrix}{ϕ}_{{u}_{i}} ← {ϕ}_{{u}_{i}} - \frac{{β}_{{u}_{i}} v ( c , {ω}_{3 , k} )}{{( {β}^{2} + {β}_{{u}_{i}}^{2} )}^{\frac{1}{2}}} \\ {β}_{{u}_{i}}^{2} ← {β}_{{u}_{i}}^{2} ( 1 - \frac{{β}_{{u}_{i}}^{2} w ( c , {ω}_{3 , k} )}{{β}^{2} + {β}_{{u}_{i}}^{2}} ) \\ c = \frac{\text{?}}{{( {β}^{2} + {β}_{{u}_{i}}^{2} )}^{\frac{1}{2}}}\end{matrix} \\ \text{?} \text{indicates text missing or illegible when filed} \qquad ( 27 )$$

where ω_{3,k} is a coefficient whose value is given in the equation:

$${ω}_{3 , k} = 1 - \frac{λ P ( {S}_{{u}_{l}} = 0 ) g ( k - 1 , l )}{P ( {S}_{{u}_{l}} = 1 ) + P ( {S}_{{u}_{l}} = 0 ) ( ( 1 - λ ) {\sum }_{j = l}^{k - 2} g ( j , l ) + g ( k - 1 , l ) )} \qquad ( 28 )$$

The parameters for the features and the real relevance are kept the same.

The formulas presented above for calculating the PCC parameters may be used to construct a PCC training algorithm that may be summarized by the following algorithm:

| 1. | Initialize aᵤ, fᵢ and sᵤ (∀u, i) to the prior distribu- |
|---|---|
| tion N( −0.5, 0.5). | |
| 2. | For each session |
| 3. | If l = 0, update each document with (23) |
| 4. | Else |
| 5. | For k = 1 to M |
| 6. | If k < l, Cₖ = 0, update (24) |
| 7. | If k < l, Cₖ = 1, update (25),(26) and (27) |
| 8, | If k = l, update (28),(29) and (30) |
| 9. | If k > l, update (31) |
| 10. | Endfor |
| 11. | Endif |
| 12. | End |

Given a collection of training search sessions, the parameters are sequentially updated as described above. Since the update formula is in closed form, the algorithm can be trained on a large scale with a large constantly growling set of log data. After training the PCC model, the user satisfaction probability can be set to zero, i.e., P(S=1|C=1)=0, for those documents have never been clicked.

The PCC model may follow the assumption in the DBN model to distinguish between the perceived relevance P(A=1|E=1) and the actual relevance P(S=1|C=1).

The document relevance may be inferred from the PCC model as follows:

$$\begin{matrix}{rel}_{u} = P ( A = 1 \vert E = 1 ) P ( {S}_{u} = 1 \vert C = 1 ) \\ = Φ ( \frac{{ϕ}_{u}}{{( {β}_{u}^{2} + {β}^{2} )}^{\frac{1}{2}}} ) Φ ( \frac{{θ}_{u} + {\sum }_{i = 1}^{n} {y}_{u , i} {m}_{i}}{{( {ρ}_{u}^{2} + {β}^{2} + {\sum }_{i = 1}^{n} {y}_{u , i} {γ}_{i}^{2} )}^{\frac{1}{2}}} )\end{matrix}$$

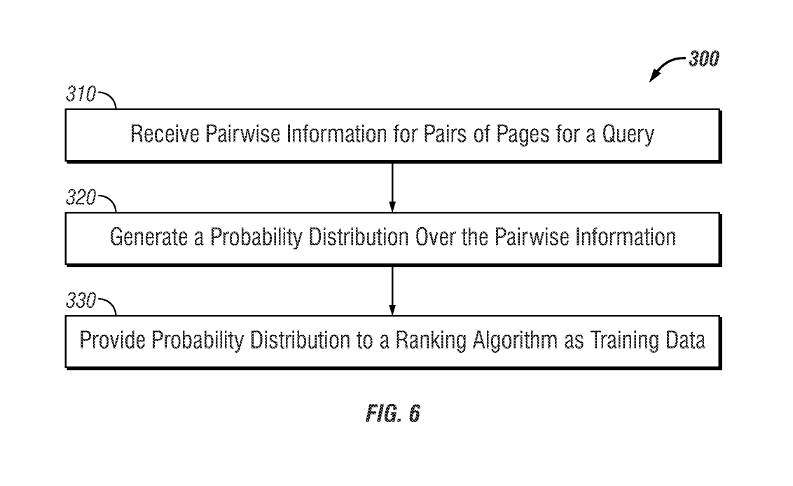

FIG. 5 is an operational flow of an implementation of a method 200 of generating training data from click logs. At 210, log data may be retrieved from one or more click logs and/or any resource that records user click behavior such as toolbar logs. The log data may be analyzed at 220 to calculate the PCC model parameters in the manner described above. Next, at 230 the relevance of each document is determined from the log data in accordance with equation 32. At 240, the results of the relevance determination may be converted into training data. In one implementation, described with respect to FIG. 6, the training data may comprise the relevance of a page with respect to another page for a given query. The training data may take the form that one page is more relevant than another page for the given query. In other implementations, a page may be ranked or labeled with respect to the strength of its match or relevance for a query. The ranking may be numerical (e.g., on a numerical scale such as 1 to 5, 0 to 10, etc.) where each number pertains to a different level of relevance or textual (e.g., “perfect”, “excellent”, “good”, “fair”, “bad”, etc.).

FIG. 6 is an operational flow of another implementation of a method 300 of generating training data from click logs. At 310, the pairwise information for pairs of pages for a query may be received. At 320, a probability distribution over the pairwise information may be generated. The probability distribution corresponds to how strongly one page should be ranked over another page for a given query. Any distribution may be used, such as a uniform distribution (i.e., each pair is equal in weight and consideration) or a weight can be assigned based on the extent to which a page A is preferred over a page B, i.e., how much the count of A B exceeds the count of B. At 330, the probability distribution may be provided to a ranking algorithm as training data.

The effectiveness of the PCC model was measured by comparing the ranking it produces to the ranking produced by the DBN model and the Click Chain Model (CCM). The effectiveness of the model was quantified using three well known measures: Normalized Discount Cumulative Gain (NDCG), click perplexity, and pairwise relevance.

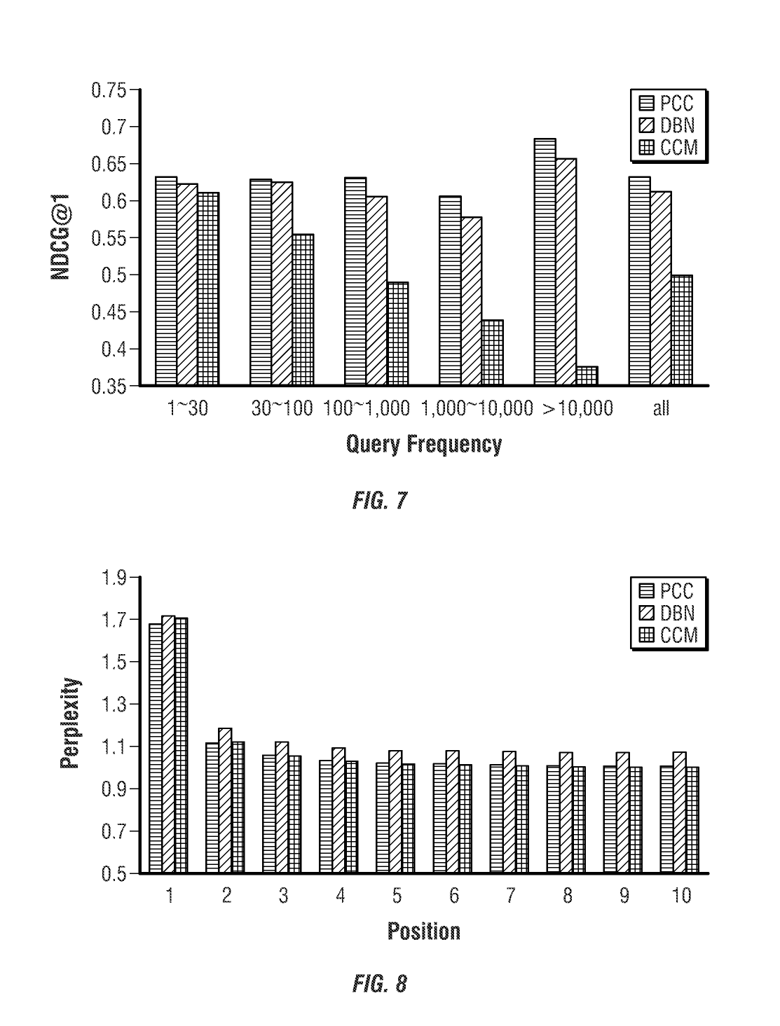

The NDGC measure or metric yields information evaluating the quality and relevance of the ranked search results. Higher NDCG values may correspond to better correlation with human judgments. FIG. 7 compares the NDCG metric among the three models in terms of the query frequency, which is a measure of how often a given query is searched. The data demonstrates that the relevance inferred from the PCC model is consistently better than that from the DBN and CCM models.

The click perplexity measure or metric yields information evaluating the predictive accuracy of the click models. That is, the click perplexity measures the accuracy of the click models' predicted percentage of users who click on each search result in a search result set. FIG. 8 compares the NDCG metric among the three models in terms of the search position of a search result. Higher click perplexity values correspond to better performance. Once again, the data demonstrates that the performance of the PCC model is consistently better than that from the DBN and CCM models. Similar results were obtained when the pairwise relevance was measured.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, machine-readable or computer readable media can include but are not limited to any non-transitory computer-readable storage media such as magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of generating training data for a search engine, comprising:
retrieving log data pertaining to user click behavior and user post-click behavior;
analyzing the log data to determine a relevance of each of a plurality of pages for a query; and
converting the relevance of the pages into training data.

2. The method of claim 1 wherein analyzing the log data includes extracting at least one feature from the user post-click behavior.

3. The method of claim 2 wherein each of the pages is associated with a search result and the feature includes a dwell time on a target page when a user clicks on one of the search results.

4. The method of claim 2 wherein each of the pages is associated with a search result and the feature includes a plurality of features selected from the group consisting of a user dwell time on a target page when a user clicks on of the search results, a user dwell time on a subsequent page that the user clicks on from the target page and which is within a domain to which the target page belongs, a time between initiation of the query and a new query, whether the user clicks on a subsequent page available from the target page, and whether the user switches to another search engine to input the query.

5. The method of claim 2 wherein analyzing the log data includes determining an average value of the feature over multiple search sessions.

6. The method of claim 1 wherein analyzing the log data includes analyzing the log data based on a likelihood-based inference using a probabilistic graphical model.

7. The method of claim 6 wherein the probabilistic graphical model is a Bayesian network.

8. The method of claim 7 wherein the Bayesian network is based on a model that includes a parameter for perceived relevance of a page prior to being clicked and actual relevance of the page after being clicked.

9. The method of claim 8 wherein the Bayesian network is based on a model that further includes a parameter for a plurality of features extracted from the post-click behavior.

10. The method of claim 8 wherein the model weighs more highly clicked pages that appear lower in a list of query results than clicked pages that appear higher in the list of query results.

11. The method of claim 1 wherein retrieving log data comprises retrieving the log data from a click log.

12. A computer-readable medium comprising computer-readable instructions for generating training data, said computer-readable instructions comprising instructions that:
retrieve log data from a click log, the log data comprising a query, a result set, at least one page of the result set that was clicked by a user and user behavior data pertaining to user click behavior and user post-click behavior;
analyze the log data to determine a relevance of each of the pages of the result set; and
provide each of the pages with a ranking based on the relevance of each of the pages for the query.

13. The computer-readable medium of claim 12, wherein the ranking comprises a label.

14. The computer-readable medium of claim 12, wherein the ranking is numerical or textual.

15. The computer-readable medium of claim 12, further comprising instructions that provide the ranking of each of the pages to a search engine as training data.

16. The computer-readable medium of claim 12 wherein the computer instructions that retrieve log data include computer instructions that extract at least one feature from the user post-click behavior, one of the features including a dwell time on a target page clicked on by the user.

17. The computer-readable medium of claim 12 wherein the computer instructions that retrieve log data include computer instructions that extract a plurality of features from the user post-click behavior selected from the group consisting of a user dwell time on a target page clicked on by the user, a user dwell time on a subsequent page that the user clicks on from the target page and which is within a domain to which the target page belongs, a time between initiation of the query and a new query, whether the user clicks on a subsequent page available from the target page, and whether the user switches to another search engine to input the query.

18. A method for determining relevance of a document to a query, comprising:
initializing values of a perceived and actual relevance of the document and a value of at least one user post-click behavior feature;
updating parameters that define the perceived and actual relevance of the document and the user post-click behavior feature based on a position of the document in a search result set for the query relative to a position of a last clicked document; and
determining a document relevancy with respect to the query from the updated parameters.

19. The method of claim 18 wherein, if the position of the document in the search result set is before the position of the last clicked document and the document is not clicked, updating parameters relating to the value of the perceived relevance and while leaving parameters relating to the values of actual relevance and the user post-click behavior feature unchanged.

20. The method of claim 18 wherein, if the position of the document in the search result set is before the position of the last clicked document and the document is clicked, updating parameters relating to the value of the perceived relevance, the actual relevance and the user post-click behavior feature.
